(19) United States
(12) Patent Application Publication
(10) Pub. No.: US 2014/0147378 A1
(43) Pub. Date: May 29, 2014

(54) METHOD FOR PREPARING CHA-TYPE MOLECULAR SIEVES USING COLLOIDAL ALUMINOSILICATE

(71) Applicants: Tracy Margaret Davis, Novato, CA (US); Saleh Ali Elomari, Fairfield, CA (US); Stacey Ian Zones, San Francisco, CA (US)

(72) Inventors: Tracy Margaret Davis, Novato, CA (US); Saleh Ali Elomari, Fairfield, CA (US); Stacey Ian Zones, San Francisco, CA (US)

(73) Assignee: CHEVRON U.S.A. INC., San Ramon, CA (US)

(21) Appl. No.: 14/079,926

(22) Filed: Nov. 14, 2013

Related U.S. Application Data
(60) Provisional application No. 61/729,621, filed on Nov. 25, 2012.

(51) Int. Cl. C01B 39/48

(52) U.S. Cl. CPC C01B 39/48
USPC 423/703; 423/704

(57) ABSTRACT

The present invention is directed to a process for preparing CHA-type molecular sieves using a colloidal aluminosilicate composition containing at least one cyclic nitrogen-containing cation suitable as directing agents for synthesizing CHA-type molecular sieves.

### FIELD OF THE INVENTION

The present invention is directed to a process for preparing CHA-type molecular sieves using a colloidal aluminosilicate composition containing one or more structure directing agents suitable for synthesizing CHA-type molecular sieves.

### BACKGROUND OF THE INVENTION

Molecular sieves are a commercially important class of crystalline materials. They have distinct crystal structures with ordered pore structures which are demonstrated by distinct X-ray diffraction patterns. The crystal structure defines cavities and pores which are characteristic of the different species.

Molecular sieves identified by the International Zeolite Associate (IZA) as having the structure code CHA are known. For example, the molecular sieve known as SSZ-13 is a known crystalline CHA material. It is disclosed in U.S. Pat. No. 4,544,538, issued Oct. 1, 1985 to Zones. In that patent, the SSZ-13 molecular sieve is prepared in the presence of a N-alkyl-3-quinuclidinol cation, a N,N,N-trialkyl-1-adamantammonium cation and/or, and N,N,N-trialkyl-2-exoaminonorbornane cation as the structure-directing agent (SDA).

U.S. Publication No. 2007-0286798 to Cao et al., published Dec. 13, 2007, discloses the preparation of CHA-type molecular sieves using various SDAs, including a N,N,N-trimethyl-2-adamantammonium cation.

However, SDAs useful for making CHA materials are complex and typically not available in quantities necessary to produce CHA materials on a commercial scale. In addition, there is a continuous need to reduce the concentration of the SDA in the reaction mixture to an absolute minimum. By doing so, the amount of excess SDA material in the reaction waste stream can be eliminated or reduced to such a low concentration that incineration of the waste stream becomes unnecessary. Thus, it would be desirable to find a way to reduce the amount of these SDAs in the synthesis of CHA-type molecular sieves.

It has now been found that CHA-type molecular sieves can be prepared using a lesser amount of the SDA as compared to known preparation methods, if the CHA material is prepared using a colloidal aluminosilicate containing at least one cyclic nitrogen-containing cation structure directing agent.

### SUMMARY OF THE INVENTION

In accordance with the present invention there is provided a method of preparing CHA-type molecular sieves by contacting under crystallization conditions (1) a colloidal aluminosilicate composition containing at least one cyclic nitrogen-containing cation; (2) at least one source of an element selected from Groups 1 and 2 of the Periodic Table; and (3) hydroxide ions.

The present invention also includes a process for preparing a CHA-type molecular sieve by:

(a) preparing a reaction mixture containing (1) a colloidal aluminosilicate composition containing at least one cyclic nitrogen-containing cation; (2) at least one source of an element selected from Groups 1 and 2 of the Periodic Table; (3) hydroxide ions; and (4) water; and

(b) subjecting the reaction mixture to crystallization conditions sufficient to form crystals of the CHA-type molecular sieve.

Where the molecular sieve formed is an intermediate material, the process of the present invention includes a further post-crystallization processing in order to achieve the target molecular sieve (e.g. by post-synthesis heteroatom lattice substitution or acid leaching).

The present invention also provides a CHA-type molecular sieve having a composition, as-synthesized and in the anhydrous state, in terms of mole ratios, as follows:

| | Broadest | Secondary |
|---|---|---|
| SiO₂/Al₂O₃ | 10-300 | 20-100 |
| Q/SiO₂ | 0.001-0.06 | 0.02-0.06 |
| M/SiO₂ | 0.02-0.14 | 0.025-0.08 |

wherein:

(1) M is selected from the group consisting of elements from Groups 1 and 2 of the Periodic Table;

(2) Q is at least one cyclic nitrogen-containing cation.

### BRIEF DESCRIPTION OF THE DRAWINGS

FIG. 1 shows a powder x-ray diffraction (XRD) pattern of the as-made aluminosilicate SSZ-13 molecular sieve prepared according to Example 4 of the present invention.

FIG. 2 shows a powder XRD pattern of the calcined aluminosilicate SSZ-13 molecular sieve prepared according to Example 4 of the present invention.

FIG. 3 shows is a scanning electron micrograph (SEM) of the calcined aluminosilicate SSZ-13 molecular sieve prepared according to Example 4 of the present invention.

### DETAILED DESCRIPTION OF THE INVENTION

### Introduction

The term “Periodic Table” refers to the version of IUPAC Periodic Table of the Elements dated Jun. 22, 2007, and the numbering scheme for the Periodic Table Groups is as described in Chemical and Engineering News, 63(5), 27 (1985).

The term “molecular sieve” includes (a) intermediate and (b) final or target molecular sieves and zeolites produced by (1) direct synthesis or (2) post-crystallization treatment (secondary synthesis). Secondary synthesis techniques allow for the synthesis of a target material from an intermediate material by heteroatom lattice substitution or other techniques. For example, an aluminosilicate can be synthesized from an intermediate borosilicate by post-crystallization heteroatom lattice substitution of the Al for B. Such techniques are known, for example as described in U.S. Pat. No. 6,790,433 to C. Y. Chen and Stacey Zones, issued Sep. 14, 2004.

Where permitted, all publications, patents and patent applications cited in this application are herein incorporated by reference in their entirety; to the extent such disclosure is not inconsistent with the present invention.

Unless otherwise specified, the recitation of a genus of elements, materials or other components, from which an individual component or mixture of components can be selected, is intended to include all possible sub-generic combinations of the listed components and mixtures thereof. Also, “include” and its variants are intended to be non-limiting, such that recitation of items in a list is not to the exclusion of other like items that may also be useful in the materials, compositions and methods of this invention.

The term “CHA-type molecular sieve” includes all molecular sieves and their isotypes that have been assigned the International Zeolite Associate framework code CHA, as described in the Atlas of Zeolite Framework Types, eds. Ch. Baerlocher, L. B. McCusker and D. H. Olson, Elsevier, 6^{th} revised edition, 2007. The Atlas of Zeolite Framework Types classes several differently named materials as having this same CHA topology, including SSZ-13 and SSZ-62.

It will be understood by a person skilled in the art that the CHA-type molecular sieve materials made according to the process described herein may contain impurities, such as amorphous materials; unit cells having non-CHA framework topologies (e.g., MFI, MTW, MOR, Beta); and/or other impurities (e.g., heavy metals and/or organic hydrocarbons).

The present invention is directed to a method of making CHA-type molecular sieves using a colloidal aluminosilicate composition containing a cyclic nitrogen-containing cation structure directing agent (SDA) selected from the group consisting of cations represented by structures (1) through (15), and mixtures thereof:

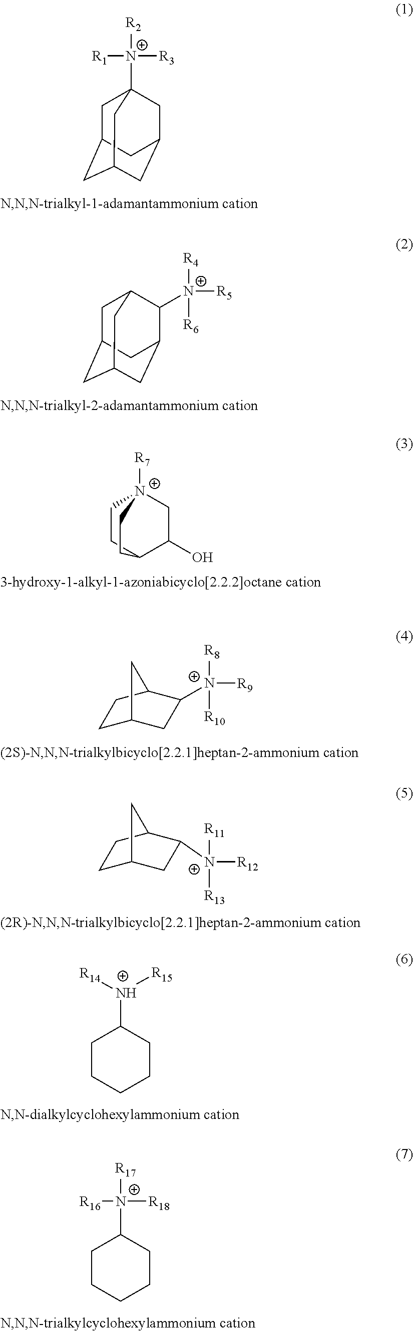

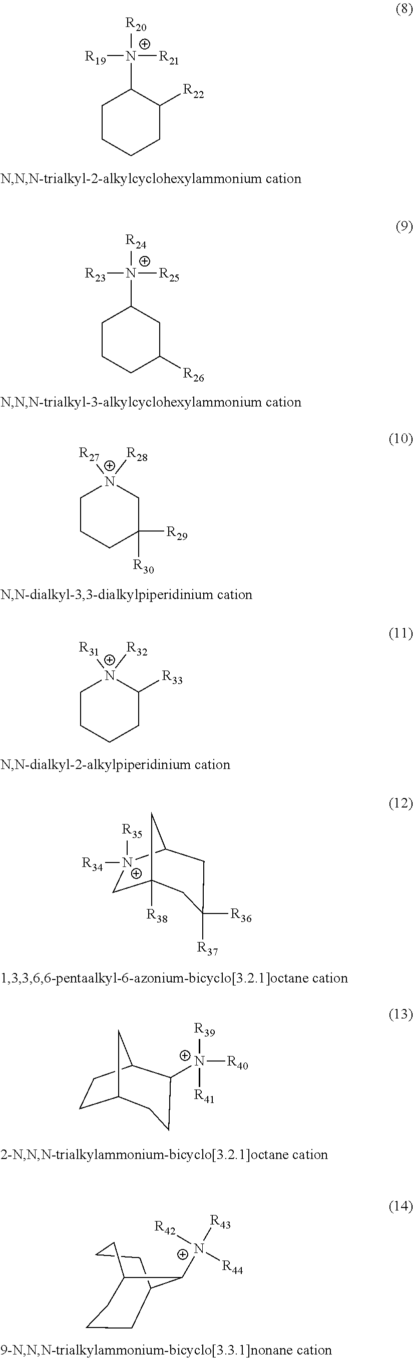

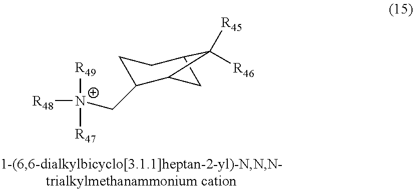

wherein R₁ through R₄₉ are each independently selected from the group consisting of a C₁-C₃ alkyl groups. In one subembodiment, each of R₁-R₄₉ is a methyl group. In another subembodiment, each of R₁-R₂₇ and R₂₉-R₄₉ is a methyl group, and R₂₈ is an ethyl group.

### Reaction Mixture

In general, the CHA-type molecular sieve is prepared by:

(a) preparing a reaction mixture containing (1) a colloidal aluminosilicate composition containing at least one cyclic nitrogen-containing cation; (2) at least one source of an element selected from Groups 1 and 2 of the Periodic Table; (3) hydroxide ions; and (4) water; and

(b) subjecting the reaction mixture to crystallization conditions sufficient to form crystals of the CHA-type molecular sieve.

Where the molecular sieve formed is an intermediate material, the process of the present invention includes a further step of synthesizing a target molecular sieve by post-synthesis techniques, such as heteroatom lattice substitution techniques and acid leaching.

The composition of the reaction mixture from which the CHA-type molecular sieve is formed, in terms of molar ratios, is identified in Table 1 below:

TABLE 1

| Reactants | Broad | Subembodiment |
|---|---|---|
| SiO₂/Al₂O₃ molar ratio | 10-300 | 20-100 |
| M/SiO₂ molar ratio | 0.1-0.4 | 0.1-0.2 |
| Q/SiO₂ molar ratio | 0.001-0.4 | 0.01-0.2 |
| OH⁻/SiO₂ molar ratio | 0.1-0.8 | 0.2-0.4 |
| H₂O/SiO₂ molar ratio | 5-40 | 15-30 |

wherein compositional variables M and Q are as described herein above.

Colloidal aluminosilicate compositions useful in the process described herein, as well as methods of making the colloidal aluminosilicates and methods for occluding templates useful for making molecular sieves, are disclosed in U.S. Publication No. 2007-0104643 to Brian Holland, published May 10, 2007.

As described herein above, for each embodiment described herein, the reaction mixture may be formed using at least one source of an element selected from Groups 1 and 2 of the Periodic Table (referred to herein as M). In one subembodiment, the reaction mixture is formed using a source of an element from Group 1 of the Periodic Table. In another subembodiment, the reaction mixture is formed using a source of sodium (Na). Any M-containing compound which is not detrimental to the crystallization process is suitable. Sources for such Groups 1 and 2 elements include oxides, hydroxides, nitrates, sulfates, halides, oxalates, citrates and acetates thereof.

The SDA cation is typically associated with anions (X⁻) which may be any anion that is not detrimental to the formation of the zeolite. Representative anions include elements from Group 17 of the Periodic Table (e.g., fluoride, chloride, bromide and iodide), hydroxide, acetate, sulfate, tetrafluoroborate, carboxylate, and the like.

The reaction mixture can be prepared either batch wise or continuously. Crystal size, morphology and crystallization time of the molecular sieve described herein may vary with the nature of the reaction mixture and the crystallization conditions.

### Crystallization and Post-Synthesis Treatment

In practice, the molecular sieve is prepared by:

(a) preparing a reaction mixture as described herein above; and

(b) maintaining the reaction mixture under crystallization conditions sufficient to form the molecular sieve. (See, Harry Robson, Verified Syntheses of Zeolitic Materials, 2^{nd} revised edition, Elsevier, Amsterdam (2001)).

The reaction mixture is maintained at an elevated temperature until the molecular sieve is formed. The hydrothermal crystallization is usually conducted under pressure, and usually in an autoclave so that the reaction mixture is subject to autogenous pressure, at a temperature between 130° C. and 200° C., for a period of one to six days.

The reaction mixture may be subjected to mild stirring or agitation during the crystallization step. It will be understood by a person skilled in the art that the molecular sieves described herein may contain impurities, such as amorphous materials, unit cells having framework topologies which do not coincide with the molecular sieve, and/or other impurities (e.g., organic hydrocarbons).

During the hydrothermal crystallization step, the molecular sieve crystals can be allowed to nucleate spontaneously from the reaction mixture. The use of crystals of the molecular sieve as seed material can be advantageous in decreasing the time necessary for complete crystallization to occur. In addition, seeding can lead to an increased purity of the product obtained by promoting the nucleation and/or formation of the molecular sieve over any undesired phases. When used as seeds, seed crystals are added in an amount between 1% and 10% of the weight of the source for compositional variable T used in the reaction mixture.

Once the molecular sieve crystals have formed, the solid product is separated from the reaction mixture by standard mechanical separation techniques such as filtration. The crystals are water-washed and then dried to obtain the as-synthesized molecular sieve crystals. The drying step can be performed at atmospheric pressure or under vacuum.

The molecular sieve can be used as-synthesized, but typically will be thermally treated (calcined). The term “as-synthesized” refers to the molecular sieve in its form after crystallization, prior to removal of the SDA. The SDA can be removed by thermal treatment (e.g., calcination), preferably in an oxidative atmosphere (e.g., air, gas with an oxygen partial pressure of greater than 0 kPa) at a temperature readily determinable by one skilled in the art sufficient to remove the SDA from the molecular sieve. The SDA can also be removed by photolysis techniques (e.g. exposing the SDA-containing molecular sieve product to light or electromagnetic radiation that has a wavelength shorter than visible light under conditions sufficient to selectively remove the organic compound from the molecular sieve) as described in U.S. Pat. No. 6,960,327 to Navrotsky and Parikh, issued Nov. 1, 2005.

The molecular sieve can subsequently be calcined in steam, air or inert gas at temperatures ranging from about 200° C. to about 800° C. for periods of time ranging from 1 to 48 hours, or more. Usually, it is desirable to remove the extra-framework cation (e.g. H⁺) by ion-exchange or other known method and replace it with hydrogen, ammonium, or any desired metal-ion.

Where the molecular sieve formed is an intermediate material, the target molecular sieve can be achieved using post-synthesis techniques such as heteroatom lattice substitution techniques. The target molecular sieve (e.g. silicate SSZ-13) can also be achieved by removing heteroatoms from the lattice by known techniques such as acid leaching.

The molecular sieve made from the process of the present invention can be formed into a wide variety of physical shapes. Generally speaking, the molecular sieve can be in the form of a powder, a granule, or a molded product, such as extrudate having a particle size sufficient to pass through a 2-mesh (Tyler) screen and be retained on a 400-mesh (Tyler) screen. In cases where the catalyst is molded, such as by extrusion with an organic binder, the molecular sieve can be extruded before drying, or, dried or partially dried and then extruded.

The molecular sieve can be composited with other materials resistant to the temperatures and other conditions employed in organic conversion processes. Such matrix materials include active and inactive materials and synthetic or naturally occurring zeolites as well as inorganic materials such as clays, silica and metal oxides. Examples of such materials and the manner in which they can be used are disclosed in U.S. Pat. No. 4,910,006, issued May 20, 1990 to Zones et al., and U.S. Pat. No. 5,316,753, issued May 31, 1994 to Nakagawa.

### Characterization of the Molecular Sieve

The CHA molecular sieves made by the process of the present invention have a composition, as-synthesized and in the anhydrous state, as described in Table 2 (in terms of mole ratios), wherein compositional variables M and Q are as described herein above:

TABLE 2

| | Broadest | Secondary |
|---|---|---|
| SiO₂/Al₂O₃ | 10-300 | 20-100 |
| Q/SiO₂ | 0.001-0.06 | 0.02-0.06 |
| M/SiO₂ | 0.02-0.14 | 0.025-0.08 |

The CHA molecular sieves synthesized by the process of the present invention are characterized by their X-ray diffraction pattern. The X-ray diffraction pattern lines of Table 3 are representative of as-synthesized CHA molecular sieve made in accordance with this invention. Minor variations in the diffraction pattern can result from variations in the mole ratios of the framework species of the particular sample due to changes in lattice constants. In addition, sufficiently small crystals will affect the shape and intensity of peaks, leading to significant peak broadening. Minor variations in the diffraction pattern can also result from variations in the organic compound used in the preparation and from variations in the Si/Al mole ratio from sample to sample. Calcination can also cause minor shifts in the X-ray diffraction pattern. Notwithstanding these minor perturbations, the basic crystal lattice structure remains unchanged.

TABLE 3
Characteristic Peaks for As-Synthesized CHA-type Molecular Sieves

| | | Relative Integrated |
|---|---|---|
| 2 Theta^{(a)} | d-spacing (Angstroms) | Intensity (%) |
| 9.52 | 9.28 | VS |
| 14.00 | 6.32 | M |
| 16.18 | 5.47 | VS |
| 17.76 | 4.99 | M |
| 20.84 | 4.26 | VS |
| 22.70 | 3.91 | W |
| 24.98 | 3.56 | S |
| 26.32 | 3.38 | W |
| 30.84 | 2.89 | S |
| 31.24 | 2.86 | M |

^{(a)}±0.20
^{(b)}The X-ray patterns provided are based on a relative intensity scale in which the strongest line in the X-ray pattern is assigned a value of 100: W(weak) is less than 20; M(medium) is between 20 and 40; S(strong) is between 40 and 60; VS(very strong) is greater than 60.

The X-ray diffraction pattern lines of Table 4 are representative of calcined CHA-type zeolites made in accordance with this invention.

TABLE 4
Characteristic Peaks for Calcined CHA-type Molecular Sieves

| | | Relative Integrated |
|---|---|---|
| 2 Theta^{(a)} | d-spacing (Angstroms) | Intensity (%) |
| 9.62 | 1.19 | VS |
| 13.04 | 6.78 | M |
| 16.22 | 5.50 | M |
| 17.98 | 4.93 | M |
| 20.88 | 4.25 | VS |
| 23.36 | 3.80 | W |
| 25.24 | 3.52 | M |
| 26.26 | 3.39 | W |
| 31.08 | 2.87 | M |
| 31.44 | 2.84 | M |

^{(a)}±0.20
^{(b)}The X-ray patterns provided are based on a relative intensity scale in which the strongest line in the X-ray pattern is assigned a value of 100: W(weak) is less than 20; M(medium) is between 20 and 40; S(strong) is between 40 and 60; VS(very strong) is greater than 60.

The powder X-ray diffraction patterns presented herein were collected by standard techniques. The radiation was CuK-α radiation. The peak heights and the positions, as a function of 2θ where θ is the Bragg angle, were read from the relative intensities of the peaks, and d, the interplanar spacing in Angstroms corresponding to the recorded lines, can be calculated.

### EXAMPLES

The following examples demonstrate but do not limit the present invention.

### Example 1

### Unseeded Synthesis of SSZ-13(SDA/SiO₂=0.04)

A 23 cc Teflon liner was charged with 8.05 g of a colloidal aluminosilicate (TX-15595, provided by Nalco Company) containing N,N,N-trimethyl-1-admanatammonium hydroxide as the SDA (SDA/SiO₂=0.04), 3.75 g 1N KOH solution, and 1.23 gm of deionized water. The mixture was thoroughly mixed. The resulting gel was capped off and sealed in a stainless steel autoclave and heated at 170° C. while rotating at about 43 rpm and monitoring the crystallization progress by SEM and pH every 3-4 days. The crystallization was complete after 7 days of heating. The crystallization products were recovered by filtration followed by thoroughly rinsing with deionized water. The products were dried in air over night followed by drying in an oven at 115° C. to give 1.62 g of SSZ-13 (>98% yield based on the19.4% solids in the Nalco colloidal aluminosilicates.

### Example 2

### Unseeded Synthesis of SSZ-13(SDA/SiO₂=0.08)

A 23 cc Teflon liner was charged with 8.05 g of a colloidal aluminosilicate (TX-15595, provided by Nalco Company) containing N,N,N-trimethyl-1-admanatammonium hydroxide as the SDA (cation/SiO₂=0.08), 3.75 g 1N KOH solution, and 1.23 g of deionized water. The mixture was thoroughly mixed. The resulting gel was capped off and sealed in a stainless steel autoclave and heated at 170° C. while rotating at about 43 rpm and the progress was monitored by pH and SEM analysis every 3-4 days. The crystallization was complete after 7 days.

The crystallization products were recovered by filtration followed by thoroughly rinsing with deionized water. The products were dried in air over night followed by drying in an oven at 115° C. to give 1.64 g of SSZ-13 (98% yields based on 19.6% solids in the colloidal aluminosilicate).

### Example 3

### Seeded Synthesis of SSZ-13 (SDA/Si=0.04)

8.14 g of a colloidal aluminosilicate composition (TX-15595, provided by Nalco Company) containing cationic N,N,N-trimethyl-1-adamantammonium as the SDA (SDA/Si=0.04) was mixed with 2.33 g of water and 2.5 g of 1N KOH solution in a Teflon cup. To this mixture, 0.05 g of chabazite seed crystals were added. The mixture was stirred by hand using a spatula until a homogeneous gel formed. The final molar composition of the gel was:

25 SiO₂: 0.71 Al₂O₃: 625 H₂O: 1 SDA-OH: 2.5 KOH

At this point, the Teflon cup was closed and sealed in a stainless steel autoclave. The reaction was heated at 170° C. while rotating at 43 rpm for 4 days. Upon crystallization, the gel was recovered from the autoclave, filtered and rinsed with deionized water. The reaction afforded 1.62 g of SSZ-13.

CHN combustion analysis of the as-made product showed a total of 10.94 wt. % organic mass in the pores (8.23% carbon, 0.78% nitrogen, and 1.93% hydrogen) indicating 10.94% N,N,N-trimethyl-1-adamantammonium cation was present in the product molecular sieve.

### Example 4

### Seeded Synthesis of SSZ-13(SDA/SiO₂=0.08)

A 23 cc Teflon liner was charged with 8.05 g of a colloidal aluminosilicate (TX-15595, provided by Nalco Company) containing N,N,N-trimethyl-1-admanatammonium hydroxide as the SDA (SDA/SiO₂=0.08), 3.75 g 1N KOH solution, and 1.23 gm of deionized water. Then, 0.05 g SSZ-13 zeolite seed was added. The mixture was thoroughly mixed. The resulting gel was capped off and sealed in a stainless steel autoclave and heated at 170° C. while rotating for 4 days. The crystallization was complete after 4 days. The crystallization products were recovered by filtration followed by thoroughly rinsing with deionized water. The products were dried in air over night followed by drying in an oven at 115° C. to give 1.5 g SSZ-13.

CHN combustion elemental analysis of the as-made sample of this example showed a total of 18.93% of organic mass in the pores with 14.9 wt. % C, 2.7 wt. % H and 1.33 wt % which indicates that the SDA, N,N,N-trimethyl-1-admanatammonium, accounts for 18.93% of total mass of the produced SSZ-13.

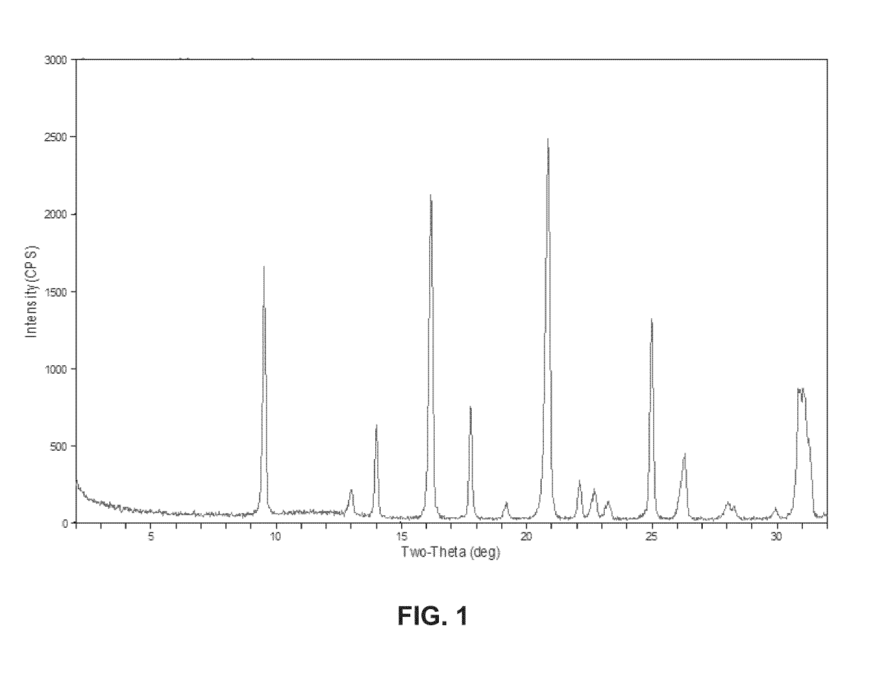

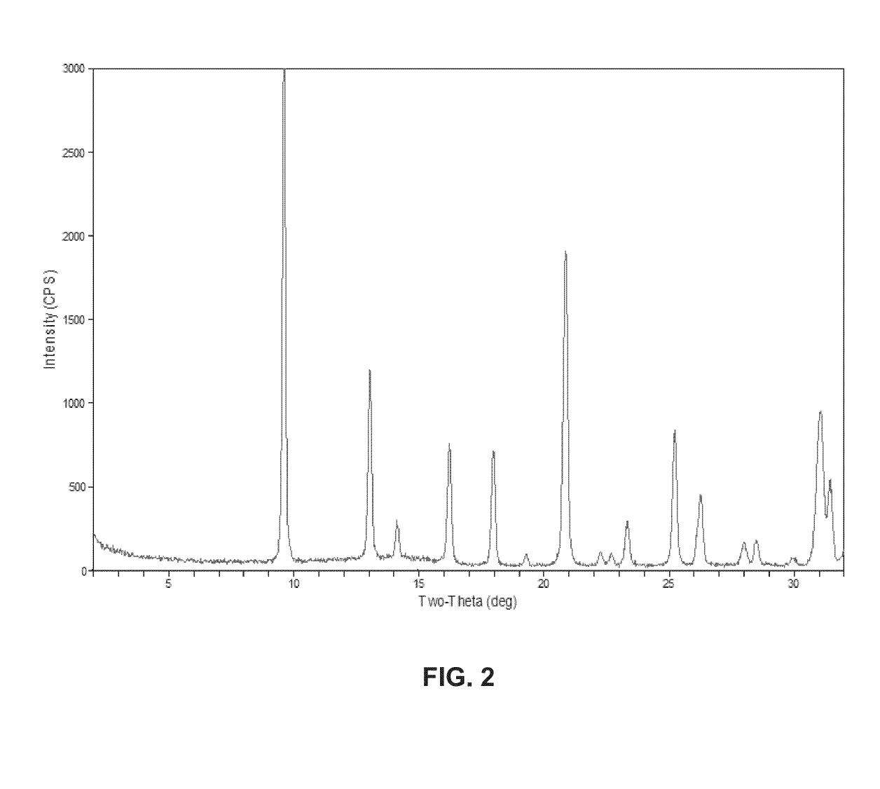

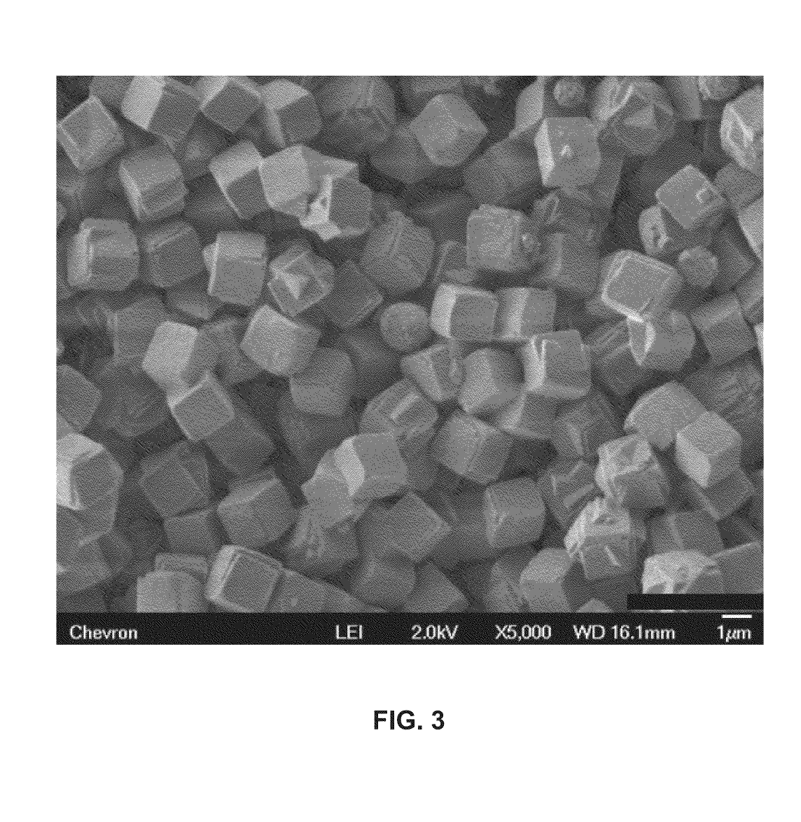

The as-made product was analyzed by XRD and the resulting pattern is illustrated in FIG. 1. The product was then calcined and the calcined product was analyzed by XRD and SEM, and the resulting pattern and micrograph are illustrated in FIGS. 2 and 3, respectively.

### Example 5

### 1 L Synthesis of SSZ-13(SDA/SiO₂=0.08)

Example 4 was repeated but on a 1-liter scale synthesis. A 1-liter Teflon liner was charged with 348.5 grams colloidal aluminosilicate (TX-15595, provided by Nalco Company) with 19.6% solids content and with a SiO₂/Al₂O₃ ratio of 28.44, and containing N,N,N-trimethyl-1-admanatammonium hydroxide as the SDA (SDA/SiO₂ ratio=0.08). To the colloidal aluminosilicate, 162 grams of a 1N KOH aqueous solution and 55 g deionized water were added. The mixture was thoroughly stirred with a Teflon spatula until well homogenous mixture was obtained. Then, 2 gm of as-made SSZ-13 was added as seeds and the mixture was stirred again for about 5 minutes. The resulting gel was sealed into a 1-liter autoclave and heated to 170° C. while stirring at 75 rpm for 4 days. The reaction was complete as determined by SEM and XRD analysis. The liner contents were then filtered and the obtained cake was thoroughly rinsed with water and analyzed once again by SEM and XRD. The reaction afforded 68 grams of pure CHA (SSZ-13) product.

The material was calcined using the following procedure. A thin layer of the as-made material in a calcination dish was heated in three stages in an atmosphere of air in a muffle furnace. The sample was heated from room temperature to 120° C. at a rate of 1° C. per minute and held there for 2 hours. Then the temperature was ramped up at a rate of 1° C. per minute to 540° C. and held there for 5 hours. In the final stage, the temperature was ramped up at a rate of 1° C./min to 595° C. and held there for 5 hours. The muffle furnace was then cooled to room temperature. The sample was removed and weighed.

Upon calcination to remove the SDA, the sample lost 13.7 wt %. Micropore analysis indicated a micropore volume of 0.269 cc/g.

Elemental analysis at Galbraith labs of the calcined material indicated a SAR (SiO₂/Al₂O₃) ratio of 20.9 at 3 wt % Al and 32.7 wt % Si. Also, it contained 1.85 wt % K.

### Example 6

### Dual-Template Synthesis of SSZ-13

3.73 g of a colloidal aluminosilicate composition (TX-15866, provided by Nalco Company) containing N,N,N-trimethyl-1-adamantammonium (ADA) and trimethylcyclohexylammonium (TMC) cations as the SDA molecules (TMC/Si=0.16, ADA/Si=0.04) was mixed with 1.33 g of water and 0.124 g of 45 wt % KOH solution in a Teflon cup. To this mixture, 0.007 g of chabazite seed crystals were added. The mixture was stirred by hand using a spatula until a homogeneous gel formed. The final molar composition of the gel was:

25 SiO₂: 0.71 Al₂O₃: 625 H₂O: 5 SDA-OH: 2.5 KOH

At this point, the Teflon cup was closed and sealed in a stainless steel autoclave. The reaction was heated at 170° C. while rotating at 43 rpm for 4 days. Upon crystallization, the gel was recovered from the autoclave, filtered and rinsed with deionized water. Analysis of the product by XRD showed the product to be pure CHA.

Elemental analysis by ICP showed the product CHA crystals to have SiO₂/Al₂O₃=32. Micropore volume as determined by nitrogen adsorption of the calcined crystals was 0.29 cc/g.

### Example 7

### Dual-Template Synthesis of SSZ-13

3.95 g of a colloidal aluminosilicate composition (TX-15866, provided by Nalco Company) containing N,N,N-trimethyl-1-adamantammonium (ADA) and trimethylcyclohexylammonium (TMC) cations as the SDA molecules (TMC/Si=0.12, ADA/Si=0.03) was mixed with 1.11 g of water and 0.124 g of 45 wt % KOH solution in a Teflon cup. To this mixture, 0.007 g of chabazite seed crystals were added. The mixture was stirred by hand using a spatula until a homogeneous gel formed. The final molar composition of the gel was:

25 SiO₂: 0.71 Al₂O₃: 625 H₂O: 3.75 SDA-OH: 2.5 KOH

At this point, the Teflon cup was closed and sealed in a stainless steel autoclave. The reaction was heated at 170° C. while rotating at 43 rpm for 10 days. Upon crystallization, the gel was recovered from the autoclave, filtered and rinsed with deionized water. Analysis of the product by XRD showed the product to be pure CHA.

What is claimed is:

1. A method of preparing a CHA-type molecular sieve, comprising:
(a) preparing a reaction mixture containing (1) a colloidal aluminosilicate composition containing at least one cyclic nitrogen-containing cation; (2) at least one source of an element selected from Groups 1 and 2 of the Periodic Table; (3) hydroxide ions; and (4) water; and
(b) subjecting the reaction mixture to crystallization conditions sufficient to form crystals of the CHA-type molecular sieve.

2. The method of claim 1, wherein the cyclic nitrogen-containing cation is selected from the group consisting of cations having the following structures, and mixtures thereof: 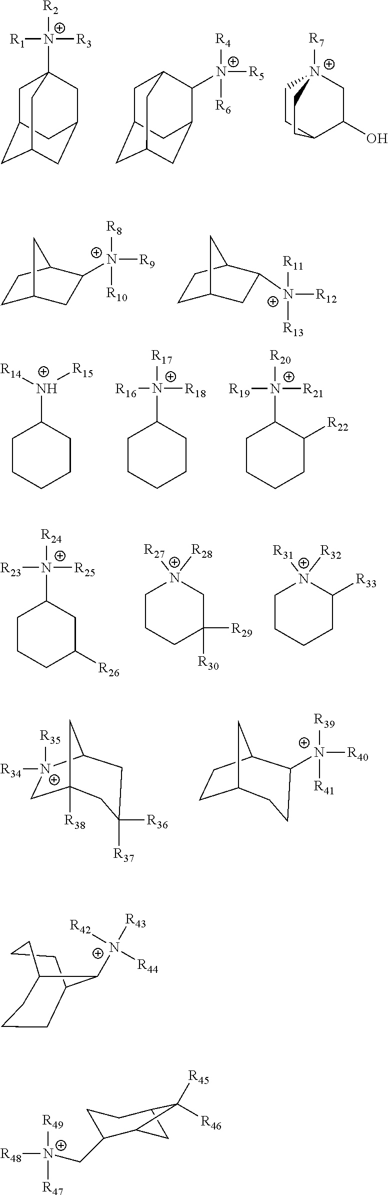
wherein R₁ through R₄₉ are each independently selected from the group consisting of a C₁-C₃ alkyl groups.

3. The method of claim 2, wherein each of R₄-R₄₉ is a methyl group.

4. The method of claim 2, wherein each of R₁-R₂₇ and R₂₉-R₄₉ is a methyl group, and R₂₈ is an ethyl group.

5. The method of claim 2, wherein the at least one cyclic nitrogen-containing cation comprises a N,N,N-trimethyl-1-adamantammonium (ADA) cation and a trimethylcyclohexylammonium cation.

6. The method of claim 1, wherein the molecular sieve is prepared from a reaction mixture comprising, in terms of mole ratios, the following:

| | |
|---|---|
| SiO₂/Al₂O₃ molar ratio | 10-300 |
| M/SiO₂ molar ratio | 0.1-0.4 |
| Q/SiO₂ molar ratio | 0.001-0.4 |
| OH⁻/SiO₂ molar ratio | 0.1-0.8 |
| H₂O/SiO₂ molar ratio | 5-40 |

wherein:
(1) M is the at least one element selected from Groups 1 and 2 of the Periodic Table; and
(2) Q is the at least one cyclic nitrogen-containing cation.

7. The method of claim 1, wherein the molecular sieve is prepared from a reaction mixture comprising, in terms of mole ratios, the following:

| | |
|---|---|
| SiO₂/Al₂O₃ molar ratio | 20-100 |
| M/SiO₂ molar ratio | 0.1-0.2 |
| Q/SiO₂ molar ratio | 0.01-0.2 |
| OH⁻/SiO₂ molar ratio | 0.2-0.4 |
| H₂O/SiO₂ molar ratio | 15-30 |

wherein:
(1) M is the at least one element selected from Groups 1 and 2 of the Periodic Table; and
(2) Q is the at least one cyclic nitrogen-containing cation.

8. The method of claim 1, wherein the molecular sieve has a composition, as made and in the anhydrous state, comprising, in terms of mole ratios, the following:

| | |
|---|---|
| SiO₂/Al₂O₃ | 10-300 |
| Q/SiO₂ | 0.001-0.06 |
| M/SiO₂ | 0.02-0.14 |

wherein:
(1) M is the at least one element selected from Groups 1 and 2 of the Periodic Table; and
(2) Q is the at least one cyclic nitrogen-containing cation.

9. The method of claim 1, wherein the molecular sieve has a composition comprising, in terms of mole ratios, the following:

| | |
|---|---|
| SiO₂/Al₂O₃ | 20-100 |
| Q/SiO₂ | 0.02-0.06 |
| M/SiO₂ | 0.025-0.08 |

wherein:
(1) M is the at least one element selected from Groups 1 and 2 of the Periodic Table; and
(2) Q is the at least one cyclic nitrogen-containing cation.
